(19) United States
(12) Patent Application Publication
(10) Pub. No.: US 2009/0267885 A1
(43) Pub. Date: Oct. 29, 2009

(54) PIXEL CIRCUITRY AND DRIVING METHOD THEREOF

(75) Inventor: Cheng-Chi Yen, Tainan County (TW)

Correspondence Address: J C PATENTS, 4 VENTURE, SUITE 250, IRVINE, CA, 92618, US

(73) Assignee: HIMAX DISPLAY, INC., Tainan County (TW)

(21) Appl. No.: 12/109,606

(22) Filed: Apr. 25, 2008

(51) Int. Cl. G09G 3/36

(52) U.S. Cl. 345/98

(57) ABSTRACT

A pixel circuitry for a display apparatus and a driving method thereof are provided. The pixel circuitry includes a storage element, a scan switch, a first control circuit and a second control circuit. The scan switch delivers a pixel signal to the storage element in response to a scan signal during a frame period. The storage element having a first terminal and a second terminal is used for storing the pixel signal. The first control circuit selectively provides a reference voltage to one of the first and the second terminals of the storage element. The second control circuit selectively connects a pixel electrode to one of the first and the second terminals of the storage element. Under the control of the first and the second control circuits, the polarity of the pixel signal stored in the storage element can be changed by adjusting two terminal voltages of the storage element.

### BACKGROUND OF THE INVENTION

1. Field of the Invention

The present invention relates to a pixel circuitry and a driving method thereof, and more particularly, to a circuitry that utilizes the characteristic of the storage element to change the polarity of a pixel signal stored in the storage element.

2. Description of Related Art

FIG. 1 is a diagram of a conventional pixel cell. Referring to FIG. 1, the pixel cell 100 includes a transistor T1, a storage capacitor Csc and a liquid crystal layer Clc. It is assumed that the transistor T1 has a gate, a drain and a source respectively connected to a scan line, a data line and a pixel electrode Pi. When the transistor T1 is conducted, in the meanwhile, the pixel electrode Pi is connected to the data line and receives a corresponding pixel signal through the data line for charging the pixel electrode Pi to a proper voltage. Next, the transistor T1 is turned off and the electric charge corresponding to the pixel signal is stored in the storage capacitor Csc for controlling the rotation of the liquid crystal and the light transmission corresponding to pixel cell 100.

As known, polarity inversion is an important concept for driving the liquid crystal. An inversed electric field is provided to the liquid crystal into different frame periods for eliminating the DC residue of the liquid crystal. For this reason, an external frame buffer is often needed to increase the frame rate for executing the polarity inversion and for avoiding flickers. However, an additional cost will be increased.

### SUMMARY OF THE INVENTION

Accordingly, the present invention provides a pixel circuitry for a display apparatus and a driving method thereof that utilizes the characteristic of the storage element to change the polarity of the pixel signal stored in the storage element during a frame time. Therefore, the present invention can achieve the function of frame buffer and increase the frame rate by once writing data to the pixel circuitry.

A pixel circuitry for a display apparatus is provided in the present invention. The pixel circuitry includes a storage element, a scan switch, a first control circuit and a second control circuit. The scan switch delivers a pixel signal to the storage element in response to a scan signal during a frame period and the storage element stores the pixel signal. The first control circuit selectively provides a reference voltage to one of the first terminal and the second terminal of the storage element. The second control circuit selectively connects a pixel electrode to one of the first terminal and the second terminal of the storage element.

According to an embodiment of the foregoing pixel circuitry, the first control circuit includes a first switch and a second switch. The first switch is coupled between the first terminal of the storage element and the reference voltage. The second switch is coupled between the second terminal of the storage element and the reference voltage.

According to an embodiment of the foregoing pixel circuitry, the second control circuit includes a first switch and a second switch. The first switch is coupled between the first terminal of the storage element and the pixel electrode. The second switch is coupled between the second terminal of the storage element and the pixel electrode.

The driving method for a pixel circuitry is provided in the present invention, wherein the pixel circuitry has a storage element. First, a pixel signal is delivered to the storage element in response to a scan signal during a frame period. A reference voltage is selectively provided to one of the first terminal and the second terminal of the storage element. Besides, a pixel electrode is selectively connected to one of the first terminal and the second terminal of the storage element.

According to an embodiment of the foregoing driving method, the reference voltage is provided to the first terminal of the storage element and the pixel electrode is connected to the second terminal of the storage element while in a first polarity. Besides, the reference voltage is provided to the second terminal of the storage element and the pixel electrode is connected to the first terminal of the storage element while in a second polarity.

The present invention provides a pixel circuitry and a driving method that can change the polarity of the pixel signal stored in the storage element during a frame period. Since the storage element can keep the voltage offset between its two terminals invariable, the polarity of the pixel signal stored in the storage element can be changed by selectively providing the reference voltage to one of the first terminal and the second terminal of the storage element during the frame period. Then, the pixel signal stored in the storage element is transmitted to the pixel electrode. The pixel circuitry can achieve the function of frame buffer and increase the frame rate, which can display the pixel signal with different polarities during one frame period.

In order to make the features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional pixel cell.

FIG. 2 is a diagram of the pixel circuitry according to an embodiment of the present invention.

FIG. 3 is a timing diagram of the pixel circuitry according to the embodiment of the present invention in FIG. 2.

FIG. 4 is a flow chart of the driving method for the pixel circuitry according to the embodiment in FIG. 2.

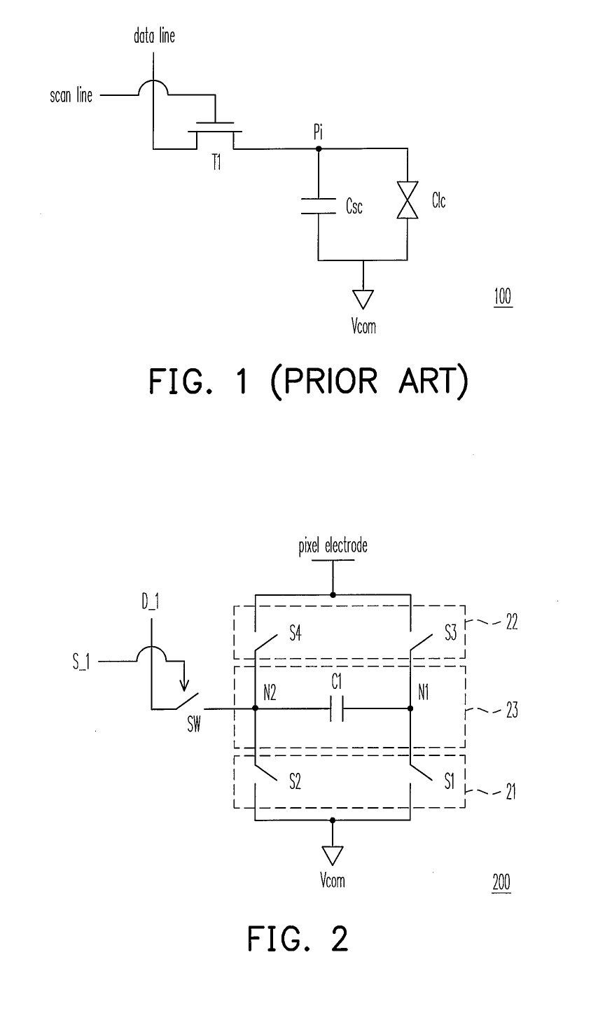

### DESCRIPTION OF EMBODIMENTS

FIG. 2 is a diagram of the pixel circuitry according to an embodiment of the present invention. Referring to FIG. 2, the pixel circuitry 200 is adapted for a display apparatus, such as the liquid crystal display (LCD) or the liquid crystal on silicon (LCOS) panel. The pixel circuitry 200 includes a storage element 23, a scan switch SW, a first control circuit 21 and a second control circuit 22. The scan switch SW has two terminals respectively coupled to a data line D_1 and the storage element 23 and the scan switch SW has a control terminal coupled to a scan line S_1. The scan switch SW delivers a pixel signal from the data line D_1 to the storage element 23 in response to a scan signal during a frame period, wherein the scan signal is transmitted to the control terminal of the scan switch SW via the scan line S_1. The storage element 23 is used for storing the pixel signal and the storage element 23 has a first terminal N1 and a second terminal N2. In the embodiment, a capacitor C1 having poly-insulator-poly (PIP) structure or metal-insulator-metal (MIM) structure is adopted to put the storage element 23 into practice. In another embodiment, a transistor type of the capacitor such as MOS capacitor is also adapted to put into practice.

The first control circuit 21 includes the switches S1 and S2. The switch S1 is coupled between the first terminal N1 of the storage element 23 and a reference voltage Vcom. The switch S2 is coupled between the second terminal N2 of the storage element 23 and the reference voltage Vcom. The reference voltage Vcom can be a common voltage of a pixel electrode. In the control of the switches S1 and S2, the first control circuit 21 selectively provides the reference voltage Vcom to one of the first terminal N1 and the second terminal N2 of the storage element 23. The second control circuit 22 includes the switches S3 and S4. The switch S3 is coupled between the first terminal N1 of the storage element 23 and the pixel electrode. The switch S4 is coupled between the second terminal N2 of the storage element 23 and the pixel electrode. In the control of the switches S3 and S4, the second control circuit 22 selectively connects the pixel electrode to one of the first terminal N1 and the second terminal N2 of the storage element 23.

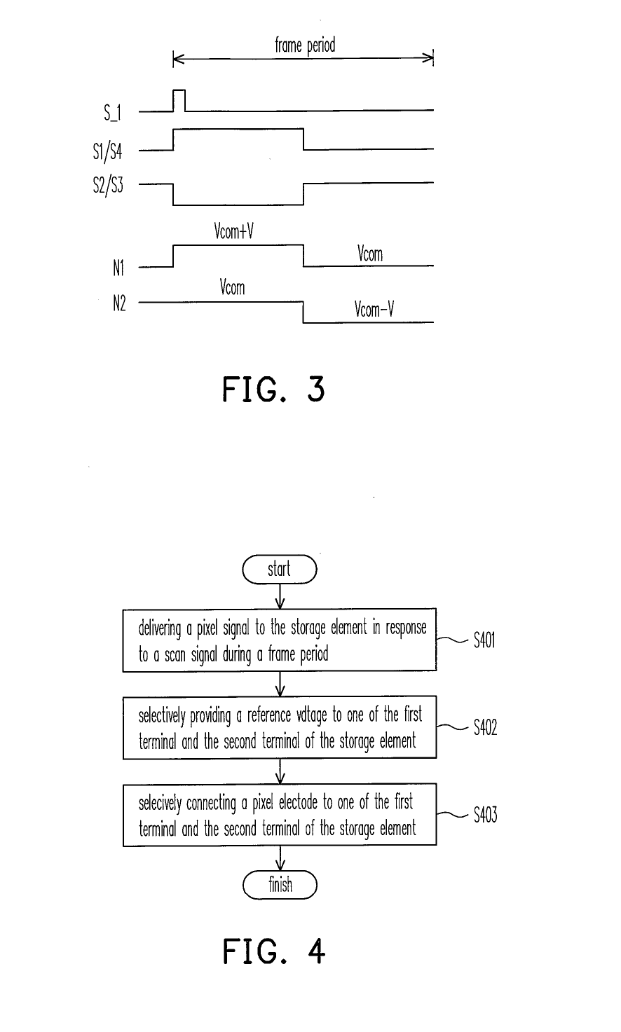

FIG. 3 is a timing diagram of the pixel circuitry according to the embodiment of the present invention in FIG. 2. Referring to FIG. 2 and FIG. 3, when the scan signal corresponding to the scan line S_1 is enabled during the frame period, the scan switch SW is conducted and the pixel signal having a voltage level, e.g. +V, is delivered to the storage element 23 via the data line D_1 for storing. Otherwise, when the scan signal corresponding to the scan line S_1 is disabled, the scan switch SW is not conducted. In the embodiment, the frame period includes a first sub-frame period and a second sub-frame period respectively corresponding to a first polarity and a second polarity. The description of the polarity here is exemplarily defined as the potential difference between the potential of the applied voltage on the pixel electrode and the potential of the reference voltage Vcom. For example, if the applied voltage on the pixel electrode is greater than the reference voltage Vcom, the potential difference is positive and it is called positive polarity. Otherwise, if the applied voltage on the pixel electrode is smaller than the reference voltage Vcom, the potential difference is negative and it is called negative polarity. While in the first polarity (e.g. positive polarity), the first control circuit 21 controls the switch S1 to be turned on and the switch S2 to be turned off for providing the reference voltage Vcom to the first terminal N1 of the storage element 23. In the meanwhile, the second control circuit 22 controls the switch S3 to be turned off and the switch S4 to be turned on for connecting the pixel electrode to the second terminal N2 of the storage element 23. As known, the storage element 23 keeps the voltage offset between two terminal N1 and N2 of the storage element 23 invariable so that the first terminal N1 and the second terminal N2 of the storage element 23 respectively have the voltage levels Vcom and Vcom+V. As a result, the polarity of the pixel signal stored in the storage element 23 is changed to positive polarity and is transmitted to the pixel electrode for driving the liquid crystal.

To reason by analogy, while in a second polarity (e.g. negative polarity), the first control circuit 21 controls the switch S1 to be turned off and the switch S2 to be turned on for providing the reference voltage Vcom to the second terminal N2 of the storage element 23 and the second control circuit 22 controls the switch S3 to be turned on and the switch S4 to be turned off for connecting the pixel electrode to the first terminal N1 of the storage element 23. Since the storage element 23 keeps the voltage offset between two terminals N1 and N2 of the storage element 23 invariable, the first terminal N1 and the second terminal N2 of the storage element 23 respectively have the voltage levels Vcom and Vcom-V. Consequentially, the polarity of the pixel signal stored in the storage element 23 is changed to negative polarity and is transmitted to the pixel electrode for driving the liquid crystal. As the foregoing description, the switches S1 and S2 included in the first control circuit 21 are alternately turned on in accordance with a polarity of the frame period, and the switches S3 and S4 included in the second control circuit 22 are also alternately turned on in accordance with a polarity of the frame period.

It is noted that in one frame period, the pixel signal is once written to the storage element 23 of the pixel circuitry 200 and the pixel circuitry 200 changes the polarity of the pixel signal in the control of the first control circuit 21 and the second control circuit 22. The pixel circuitry 200 can be utilized to display the pixel signal with positive polarity and negative polarity during the frame period without additional frame buffer for increasing the frame rate to be at least two times and the flickers can also be reduced. In idealistically, by alternately turning on the said two control circuits 21 and 22, the pixel circuitry 200 can increase the frame rate by N times, N is greater than two. Although the said embodiment utilizes the switches to control signal transmission, such as the scan switch SW and the switches S1 through S4, any person ordinary skilled in the art can use any substitute elements to implement the function of switch, such as transistors.

According to the embodiments as described above, the steps of the following method could be generalized. FIG. 4 is a flow chart of the driving method for the pixel circuitry according to the embodiment in FIG. 2. Referring to FIG. 2 and FIG. 4, in the step S401 the pixel signal is delivered to the storage element 23 in response to the scan signal during the frame period. In the step S402, the reference voltage Vcom is selectively provided to one of the first terminal N1 and the second terminal N2 of the storage element 23 for changing the polarity of the pixel signal stored in the storage element 23. In the step S403, a pixel electrode is selectively connected to one of the first terminal N1 and the second terminal N2 of the storage element 23 for transmitting the pixel signal stored in the storage element 23 to the pixel electrode. In the embodiment of the present invention, the step S402 and the step S403 can be executed substantially simultaneous. To explain further, in a first polarity, while the reference voltage Vcom provides to the first terminal N1 of the storage element 23, the pixel electrode connects to the second terminal N2 of the storage element 23 substantially at the same time. Similarly, in a second polarity, while the reference voltage Vcom provides to the second terminal N2 of the storage element 23, the pixel electrode connects to the first terminal N1 of the storage element 23 substantially at the same time.

In summary, since the storage element 23 can keep the voltage offset between its two terminals invariable, the operation of the first control circuit 21 is to change one of two terminal voltages of the storage element 23 so that the polarity of the pixel signal stored in the storage element 23 can be changed. Besides, the operation of the second control circuit 22 is to transmit the pixel signal stored in the storage element 23 to the pixel electrode, wherein the pixel signal may have different polarities. Hence, the pixel circuitry can achieve the function of frame buffer and increase the frame rate, which can display the pixel signal with different polarities during one frame period.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A pixel circuitry for a display apparatus, comprising:
a storage element having a first terminal and a second terminal for storing a pixel signal;
a scan switch for delivering the pixel signal to the storage element in response to a scan signal during a frame period;
a first control circuit for selectively providing a reference voltage to one of the first terminal and the second terminal of the storage element; and
a second control circuit for selectively connecting a pixel electrode to one of the first terminal and the second terminal of the storage element.

2. The pixel circuitry as claimed in claim 1, wherein the first control circuit provides the reference voltage to the first terminal of the storage element and the second control circuit connects the pixel electrode to the second terminal of the storage element while in a first polarity.

3. The pixel circuitry as claimed in claim 2, wherein the first control circuit provides the reference voltage to the second terminal of the storage element and the second control circuit connects the pixel electrode to the first terminal of the storage element while in a second polarity.

4. The pixel circuitry as claimed in claim 3, wherein the frame period comprises a first sub-frame period and a second sub-frame period, and the first sub-frame period corresponds to the first polarity and the second sub-frame corresponds to the second polarity.

5. The pixel circuitry as claimed in claim 1, wherein the first control circuit comprises:
a first switch coupled between the first terminal of the storage element and the reference voltage; and
a second switch coupled between the second terminal of the storage element and the reference voltage.

6. The pixel circuitry as claimed in claim 5, wherein the first switch and the second switch are alternately turned on in accordance with a polarity of the frame period.

7. The pixel circuitry as claimed in claim 1, wherein the second control circuit comprises:
a first switch coupled between the first terminal of the storage element and the pixel electrode; and
a second switch coupled between the second terminal of the storage element and the pixel electrode.

8. The pixel circuitry as claimed in claim 7, wherein the first switch and the second switch are alternately turned on in accordance with a polarity of the frame period.

9. The pixel circuitry as claimed in claim 1, wherein the reference voltage is a common voltage of the pixel electrode.

10. The pixel circuitry as claimed in claim 1, wherein one of the first control circuit and the second control circuit is operated in response to the scan signal.

11. The driving method for a pixel circuitry having a storage element, comprising
delivering a pixel signal to the storage element in response to a scan signal during a frame period;
selectively providing a reference voltage to one of a first terminal and a second terminal of the storage element; and
selectively connecting a pixel electrode to one of the first terminal and the second terminal of the storage element.

12. The driving method as claimed in claim 11, further comprising:
substantially simultaneously providing the reference voltage to the first terminal of the storage element and connecting the pixel electrode to the second terminal of the storage element in a first polarity.

13. The driving method as claimed in claim 12, further comprising:
substantially simultaneously providing the reference voltage to the second terminal of the storage element and connecting the pixel electrode to the first terminal of the storage element in a second polarity.

14. The driving method as claimed in claim 13, wherein the frame period comprises a first sub-frame period and a second sub-frame period, and the first sub-frame period corresponds to the first polarity and the second sub-frame corresponds to the second polarity.

15. The driving method as claimed in claim 11, wherein the reference voltage is a common voltage of the pixel electrode
